(19) United States
(12) Patent Application Publication
(10) Pub. No.: US 2019/0210118 A1
(43) Pub. Date: Jul. 11, 2019

(54) RELEASE UNIT FOR A MACHINE TOOL SPINDLE

(71) Applicant: FRANZ KESSLER GMBH, Bad Buchau (DE)

(72) Inventors: Joachim Van Sprang, Ravensburg (DE); Michael Bergbaur, St. Marein Bei Graz (AT); Matthias Scheffold, Bad Saulgau (DE)

(73) Assignee: FRANZ KESSLER GMBH, Bad Buchau (DE)

(21) Appl. No.: 16/289,961

(22) Filed: Mar. 1, 2019

Related U.S. Application Data
(63) Continuation of application No. PCT/EP2017/069712, filed on Aug. 3, 2017.

(30) Foreign Application Priority Data
Sep. 9, 2016 (DE) 10 2016 116 927.7

(51) Int. Cl. B23B 31/28; F16C 35/10; F16C 35/12; B23B 31/00; B23B 31/26

(52) U.S. Cl. CPC B23B 31/28; F16C 35/10; F16C 35/12; B23B 2260/062; B23B 31/261; B23B 2260/0082; B23B 31/003

(57) ABSTRACT

A release unit for a machine tool spindle, in particular motor spindle, for releasing a tool clamp, wherein the release unit comprises at least one adjustment element which can be linearly adjusted along an adjustment path for actuating the tool clamp, which release unit reduces the structural and/or economic complexity. This is achieved according to the invention in that the release unit is constructed as an electric motor which comprises an electromagnetic drive system having a hollow-cylindrical rotor shaft which rotates about a rotation axis, in that the linearly adjustable adjustment element is constructed as a spindle element of a conversion unit for converting the rotation of the electric motor into a linear adjustment and in that the rotor shaft is constructed as a spindle nut of the conversion unit which rotates about the rotation axis.

### CROSS REFERENCE TO RELATED APPLICATIONS

This application is a continuation of International Application No. PCT/EP2017/069712 filed Aug. 3, 2017, which designated the United States, and claims the benefit under 35 USC § 119(a)-(d) of German Application No. 10 2016 116 927.7 filed Sep. 9, 2016, the entireties of which are incorporated herein by reference.

### FIELD OF THE INVENTION

The present invention relates to a release unit for a machine tool spindle.

### BACKGROUND OF THE INVENTION

In machine tools, in particular, in milling machines or the like, tool clamps which enable an automatic tool change are very often used. This means that the tool is connected to the shaft of the machine tool spindle in such a manner that it can be automatically released. For clamping, in the vast majority of cases, tool clamps which are mostly connected to a spring assembly, etc., are used. The resulting clamping force is transmitted via a tension rod to collet chuck segments which in turn connect the tool to the shaft.

For release, the tension rod and consequently also the disk spring assembly are acted on with an axially active release force which presses the springs together and consequently enables an axial displacement of the tension rod which in turn leads to a release movement of the clamping segments in the region of the tool receiving member.

The axial force required for release is produced by means of so-called release units. In this instance, it is generally a piston/cylinder system which is acted on at one side with pressure. This pressure multiplied by the surface-area of the piston acts as a release force by means of a pressure contact on the tension rod. The pressure required to release the tool is either produced hydraulically (generally in the range from approximately 80 to 140 bar) or, when pneumatic release units are used, compressed air is used (generally from 5 to 6 bar) which particularly with hydraulic systems may not only be energy intensive, but also very dangerous in the event of leaks.

Thus, DE 199 37 447 A1 already discloses a release unit for a machine tool spindle, in particular, motor spindle, which is constructed as a hydraulic release unit and consequently has a hydraulic connection, in particular, a hydraulic oil connection.

The disadvantage of such hydraulic or pneumatic release units is additionally that, in addition to the electrical connection for the motor spindle or the electromagnetic drive system of the motor spindle, a hydraulic or pneumatic energy supply further has to be provided. This means for the operator of a corresponding machine tool a correspondingly high structural and financial complexity.

### SUMMARY OF THE INVENTION

An object of the present invention is in this regard to provide a release unit for a machine tool spindle, in particular, motor spindle, which decreases the structural and/or economic complexity.

A release unit according to the present invention is accordingly distinguished in that the release unit is constructed as an electric motor which comprises an electromagnetic drive system having a cylindrical rotor shaft which rotates about a rotation axis, in that the linearly adjustable adjustment element is constructed as a spindle element of a conversion unit for converting the rotation of the electric motor into a linear adjustment and in that the rotor shaft is constructed as a spindle nut of the conversion unit which rotates about the rotation axis.

Using such a release unit which is constructed as an electric motor, wherein the rotor shaft is at the same time the spindle nut of the conversion unit, a particularly space-saving electric release unit can be produced. It is thus possible with the space or structural space which is often very limited in machine tools, such as the region of a machine tool spindle or motor spindle facing away from the tool or workpiece, that is to say, at the “rear” end side of the machine tool spindle or motor spindle, to advantageously arrange the space-saving electric release unit according to the present invention.

Using the space-saving electric release unit according to the present invention, it is advantageously possible to replace a previously present small hydraulic release unit. Consequently, according to the present invention, a separate hydraulic or pneumatic energy supply for the machine tool spindle or motor spindle can be dispensed with. This means that a corresponding pressure production unit for producing the hydraulic pressure or pneumatic pressure is also unnecessary, in particular, for the machine tool manufacturer and the machine tool operator. This enables an economically particularly advantageous operating method of a machine tool according to the present invention or motor spindle/machine tool spindle.

The linearly adjustable adjustment element or spindle element of the conversion unit constructed according to the present invention thus replaces the previously available, fluid-operated piston rod which activates the clamping device or the tool clamp, in particular, releases it. Consequently, previously conventional or standardized tool clamping components of corresponding machine tool spindles/motor spindles can continue to be used without having to be changed or adapted to the advantageous electric release unit according to the present invention.

Furthermore, machine tool spindles/motor spindles according to the present invention which are already available or produced and which have even been used in operation for a long time can also be converted/retrofitted. This means that, for example, in the event of a defect or maintenance of the previous hydraulic release unit, the advantageous electric release unit according to the present invention can be installed. This is consequently particularly advantageous, not only for newly produced machine tool spindles/motor spindles, but also for machine tool spindles which are already in use.

For example, the electric release unit according to the present invention has a connection flange which substantially corresponds to a connection flange of previous hydraulic/pneumatic release units so that, for example, screwing of the electric release unit can be carried out by means of the advantageous connection flange.

Previously conventional hydraulic release units often have a rotary feedthrough or a media feedthrough for coolant and/or lubricant or the like so that at the end side from one end of the release unit corresponding medium or coolant and lubricant or the like can be directed through the release unit and through the advantageous spindle element according to the present invention to the tool clamp or as far as the tool/workpiece. The corresponding connections may in turn correspond to the previously conventional connections of hydraulic release units so that in this instance no adaptation of the media feedthrough system is also required. This reduces the complexity for the integration of the electric release unit according to the present invention or increases the compatibility of the electric release unit according to the present invention with previously conventional release units for machine tool spindles/motor spindles.

Preferably, the rotor or spindle nut is arranged coaxially with respect to the spindle element or linearly adjustable adjustment element, in particular, also a centrally arranged media feedthrough/line or a channel is also arranged coaxially relative thereto.

As a result of the construction of the hollow-cylindrical rotor shaft as a spindle nut of the conversion unit, it is advantageously possible for the electric motor as an advantageously compact structural unit at the same time to have the conversion unit. This means that there is integrated in the electric release unit according to the present invention not only the function of an electric motor, but at the same time also the conversion of the rotational movement of the electric motor into a linear adjustment or linear adjustment unit/linear drive, which leads to a particularly compact, space-saving construction of the electric release unit according to the present invention. As a result of the dual function of the electric release unit, on the one hand, as an electric motor and, on the other hand, as a linear drive, a reduction of the used, required structural elements/components is also achieved, which is not only structurally but also economically advantageous.

Furthermore, a high level of positioning precision of the spindle element is achieved by the construction of the rotor shaft as a spindle nut of the conversion unit by the direct drive according to the present invention or in that tolerances or the overall tolerance can be minimized.

Advantageously, the rotor shaft of the electric motor is constructed as a magnet carrier element which comprises at least one permanent magnet of the drive system. This leads to the permanent magnets of the electromagnetic drive system being directly arranged or fixed on the rotor shaft or the spindle nut. This means that the permanent magnets according to the present invention are arranged at/on the outer side/face of the rotor shaft or at least partially form the outwardly directed/facing surface of the rotor shaft. Where applicable, fixing components are provided to securely fix the permanent magnets to the rotor shaft. These may, for example, be bindings and/or an adhesive layer or an adhesive or the like.

Preferably, the rotor shaft of the electric motor comprises at least one thread turn, in particular, a plurality of thread turns may also be provided. This means that the thread turn(s) according to the present invention is/are arranged on/at the inner side/face of the rotor shaft or at least partially form(s) the inwardly directed/facing surface of the rotor shaft. Consequently, the rotor shaft advantageously has an inner thread of the conversion unit. The thread turn(s) as an inner thread of the rotor shaft can consequently advantageously be introduced/incorporated in the rotor shaft/spindle nut of the electric motor according to the present invention.

In particular as a result of the use of a plurality of thread turns, which are advantageously arranged beside each other, a comparatively large pitch of the thread turn(s) can be achieved so that an advantageous conversion of the rotational movement into a linear adjustment is achieved. This may be advantageous since previously corresponding release units carry out comparatively rapid axial travel movements, in particular, approximately 0.5 to 3 cm long travel actions in approximately from 0.01 to 0.3 seconds with a release force of approximately from 10 to 60 kN. Using the electric release unit according to the present invention, this may be implemented, for example, by means of comparatively great rotation speeds of several thousand revolutions per minute and/or by means of an advantageous pitch of the thread turn or the thread turns.

In principle, different thread shapes or thread turns may be provided, for example, metric or trapezoidal threads and ball screws or the like. Preferably, a comparatively small/low pitch of the thread turn(s) is provided, which advantageously leads to a relatively large/significant advance force or release force.

Thus, it is in principle conceivable for the thread turn of the rotor shaft or spindle nut of the conversion unit to be directly in contact with the corresponding thread turn of the spindle element. In a particular development of the present invention, roller members are arranged between the spindle nut and the spindle element. The conversion unit according to the present invention is thus advantageously constructed as a roller screw drive, in particular as a planetary roller screw drive, or preferably as a ball screw drive. Particularly with such screw drives, a very high linear advance movement speed and relatively large advance forces can be achieved, wherein the driving electric motor according to the present invention can be constructed in a comparatively small and consequently space-saving manner.

As a result of the advantageous use of roller members between the spindle nut and the spindle element, it is possible for the friction between the rotating component or the spindle nut and the linearly adjustable, in particular, non-rotating spindle element to be considerably reduced in comparison with a direct or immediate driving method (that is to say, without rolling members), which leads to a correspondingly small and energy-efficient construction of the electromagnetic drive system of the electric motor. This is advantageous since, particularly with the use of previously conventional tool clamps or release/clamping components of corresponding machine tool spindles/motor spindles, in particular, with so-called disk spring assemblies, a relatively large release force, for example, approximately 45 kN, is intended to be generated in the direction of the axial adjustment of the adjustment element. This standardized release force which generally cannot be changed and which is intended to be produced by a release unit can advantageously be produced by a reduction of the friction losses inside the release unit or inside the conversion unit of the electromagnetic drive system of the electric motor of the release unit according to the present invention. This means that, as a result of an advantageous reduction of the internal friction losses by means of the advantageous roller members, in particular balls, the electric motor of the release unit according to the present invention can be sized to be comparatively small and can consequently be used not only in a space-saving manner, but also in an energy-efficient manner.

With the construction of the conversion unit as a planetary roller screw drive, the roller members are constructed substantially as rollers which each have rotation axes which are in each case arranged parallel with the rotation axis of the spindle element or the rotor shaft to the greatest possible extent. Where applicable, an advantageous toothed wheel or the like is provided in order to achieve a common driving method of the rollers which are arranged almost in a uniform manner in the peripheral direction around the spindle element. The rollers and/or the advantageous toothed wheel are thus advantageously driven by the spindle nut or the rotor shaft according to the present invention or are in direct contact with the rotor shaft. The conversion unit can thus advantageously be constructed as a planetary roller screw drive.

In an advantageous embodiment of the present invention, the conversion unit is constructed as a ball screw drive, wherein the roller members are constructed as balls. Both the structural and economic complexity are thereby significantly reduced. Thus, in addition, an advantageous reduction of the outer diameter of the conversion unit or the spindle nut/rotor shaft can be carried out. With this embodiment of the conversion unit according to the present invention, it is thus possible for the spindle nut to be arranged very close to the spindle element since the roller members which are constructed as balls each protrude substantially almost halfway in the thread turn of the spindle nut, on the one hand, and, on the other hand, in the corresponding thread turn of the spindle element or accordingly fill them. A significant reduction of the minimal outer diameter of the conversion unit or outer diameter which can be achieved in comparison with a roller screw drive is thus achieved. This is achieved since, with the roller screw drive, the thread turn of the spindle nut is spaced comparatively far away from the thread turn of the spindle element or rollers which are comparatively large with respect to the balls are arranged therebetween.

The construction of the conversion unit as a ball screw drive is thus particularly advantageous since in this instance not only a particularly low level of friction can be achieved, but also, with comparatively low levels of drive power of the electromagnetic drive system or the electric motor, relatively high advance speeds or linear adjustments can be achieved. In addition, a ball screw drive is also distinguished by a high level of positioning precision or a low stick-slip behavior. A very low level of wear of a ball screw drive can also be produced so that a particularly long service-life can be achieved.

Advantageously, the rotor shaft of the electric motor comprises at least one return or a return channel for returning the roller members or balls. Preferably, the return or the return channel(s) is/are arranged between the permanent magnet(s) of the drive system and the thread turn(s). It is thus advantageously possible for the roller members or balls to be returned or transported one or more windings again as long as they move in an axial direction during operation. Where applicable, there is provided (at the end side) on the spindle nut and/or rotor shaft and/or thread turn at least one sealing element which as a stop prevent(s) the roller members/balls from moving out or “falling out”.

Preferably, in order to support the rotor shaft, the electromagnetic drive system of the electric motor is arranged between a first bearing and at least a second bearing. It is thereby possible for an advantageous bearing of the rotor shaft to be generated.

In any case, one of the bearings is constructed as a bearing unit with two roller bearings, in particular two ball bearings, which are produced in a so-called X or O arrangement. It is thereby advantageously possible for not only radial forces but also axial forces to be absorbed.

Preferably, at least one of the bearings is constructed as an angular roller bearing. It is thereby possible, using a single roller bearing, for relatively large axial and radial forces to be able to be absorbed. This means that an axial/radial bearing can thereby be produced with only a single roller bearing so that a particularly small amount of structural space is required for this bearing.

In an advantageous variant of the present invention, in order to support the spindle element, the roller members are arranged between a first plain bearing or first spindle bearing and at least a second plain bearing or second spindle bearing. Using the two spindle bearings or plain bearings, it is possible for the linear movement of the spindle element or the adjustment element to advantageously be able to be produced, in particular slide, in the longitudinal direction of the rotation axis. Preferably, an advantageous sealing or at least one sealing element/sealing ring per plain bearing is provided (in each case).

For example, at least one of the spindle bearings is constructed as a roller bearing, in particular ball/roller bearing, for supporting the spindle element with respect to the rotor shaft or spindle nut. Preferably, the rotor shaft comprises at least a first sliding face of the first plain bearing and/or a stator of the electric motor comprises at least a second sliding face of the second plain bearing. In an advantageous variant, the first plain bearing is arranged on a first end portion or a first stop element for stopping the tool clamp and/or the second plain bearing is arranged on the opposing end portion or on the end of the spindle element facing away from the tool and is in contact with the stator of the electric motor. As a result of the advantageous relatively large spacing of the two plain bearings, a very precise orientation or bearing/arrangement of the spindle element can be produced.

Advantageously, the first and/or second bearing of the rotor shaft is constructed at least as an axial bearing of the spindle element for receiving forces which are orientated in the direction of the rotation axis. The angular roller bearing of the rotor shaft is thus advantageously constructed as an axial bearing of the spindle element. Accordingly, the first or the second bearing of the rotor shaft, in particular, the angular roller bearing, absorbs the forces for releasing the tool clamp which are axially orientated via the spindle element. In addition, the forces by means of the spindle nut and/or roller members and consequently as far as the bearing of the rotor shaft are advantageously operationally connected or are advantageously transmitted/discharged so that they can advantageously be absorbed by the bearing of the rotor shaft which is already provided, in particular, by the angular roller bearing of the rotor shaft. Consequently, the complexity for the bearing of the rotor, or the rotor shaft, is reduced since this bearing is at the same time also used for the radial/axial bearing of the adjustment element or spindle element. Not only a reduction of the required bearing components but also a reduction of the structural space required is thereby advantageously achieved.

In a particular development of the present invention, a stator of the electric motor comprises at least one linear guiding device for guiding the spindle element along the adjustment path. Advantageous guiding of the spindle element in the direction of the adjustment path and consequently in order to release the tool clamp is thereby achieved. For example, the linear guiding device according to the present invention is at the same time constructed as a retention unit or stop unit for retaining/stopping the spindle element with respect to a rotation in the peripheral direction. This means that the linear guide advantageously prevents a rotation of the spindle element during operation so that a relative movement between the spindle nut and spindle element as a result of the electromagnetic drive system of the electric motor advantageously leads to the rotation of the spindle nut generating a linear displacement/adjustment of the spindle element. Consequently, a “co-rotation” of the spindle element is advantageously prevented by the linear guiding device according to the present invention. This improves the reliability or the operating method of the conversion unit.

Preferably, the linear guiding device comprises an advantageous (planar) guiding face which is orientated substantially parallel or longitudinally with respect to the rotation axis. Where applicable, this guiding face may be used to guide roller members, in particular rollers or the like. Alternatively, a sliding guide may also be produced as a linear guide. A significant aspect in this instance, as already mentioned, is the stopping or prevention of a “co-rotation” of the spindle element with the spindle nut according to the present invention. This is substantially achieved by fixing or stopping the spindle element by means of the linear guide on the stator.

In an advantageous variant of the present invention, at least one end switch and/or sensor is provided to detect an end position of the spindle element and/or the spindle nut. For example, at least one proximity sensor, in particular, in an inductive or capacitive or optical or magnetic manner, is provided. Alternatively or in combination therewith, there may be provided a rotary encoder or an incremental encoder, or the like, which establishes the revolutions or the adjustment path/adjustment angle in a peripheral direction. An indirect establishment of the linear travel or the axial adjustment path in the direction of the rotation axis can thereby be achieved. In particular, a relative rotary encoder for relatively establishing an adjustment path in a peripheral direction can advantageously be combined with an end switch or end position sensor. In contrast, an end position detection can be dispensed with as long as an absolute value encoder is used, which is, however, more complex.

As already mentioned, the release unit with the electric motor according to the present invention can substantially be combined or cooperate with already previously commercially available tool clamps. In this instance, many disk springs are provided to clamp the tool in an operating position. Using the electric release unit according to the present invention with linear adjustment or linear travel of the spindle element, however, it is also completely conceivable for the release unit to be able to be used at the same time for clamping or tensioning the tool. This means that the release unit according to the present invention with the electric motor not only generates a release force or a release travel in the direction of the tool along the rotation axis, but instead where applicable during operation also a clamping force counter to this direction, that is to say, by means of a tension rod or a tension element a tensioning of the tool in the tool retention member or the like can be generated by means of a corresponding travel or linear adjustment “to the rear” or away from the tool side of the machine tool spindle. The complexity for the tool clamping or for a machine tool spindle/motor spindle would thereby be further reduced.

In an advantageous variant of the present invention, a sensor unit for detecting an electric motor parameter is provided. For example, an evaluation of the power/power consumption and/or the operating current or of the operating voltage of the electric drive system is provided. It is thus advantageously possible to establish inter alia an idle mode and/or a release mode and, for example, to evaluate whether/that the release unit activates the clamping system or adjusts/releases the tool clamp and/or a tension rod or the like and/or whether/that the clamping system or the tool clamp and/or the tension rod is/are impaired/not impaired. Preferably, an actual/desired comparison is provided, wherein, for example, a small no-load current or no-load power and/or an electric release current or a travel/release power is compared with a (stored) desired power or the like in order to detect/establish a correct operation or clamping of the tool and/or the position or function of the clamping system and/or the tension rod.

### BRIEF DESCRIPTION OF THE DRAWINGS

An embodiment of the present invention is illustrated in the drawings and is explained in greater detail below with reference to the Figures.

FIG. 1 is a schematic first section through a release unit according to the present invention; and

FIG. 2 is a schematic second section through the release unit according to the present invention.

### DETAILED DESCRIPTION OF THE INVENTION

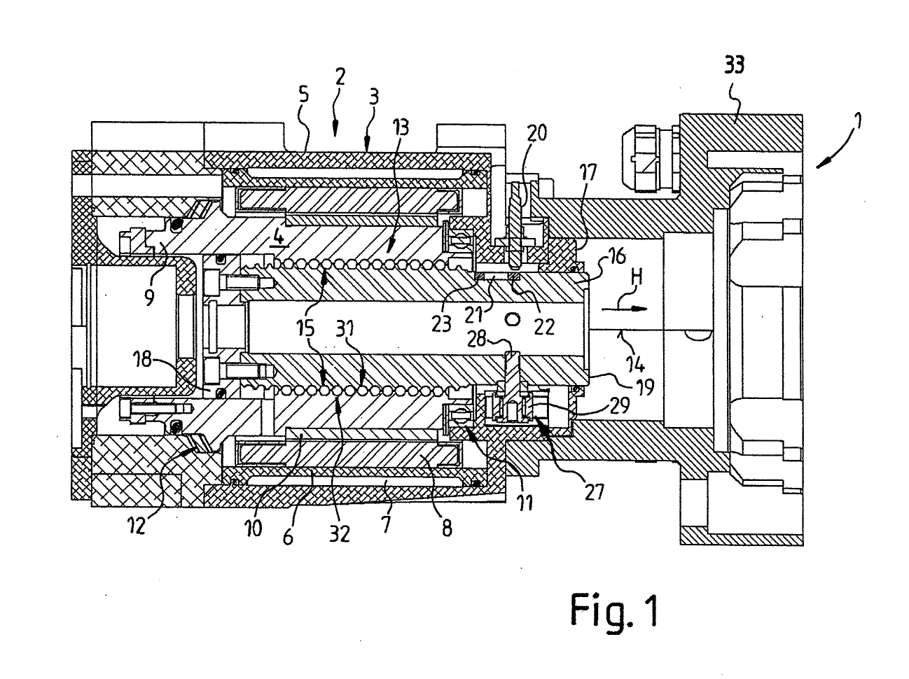

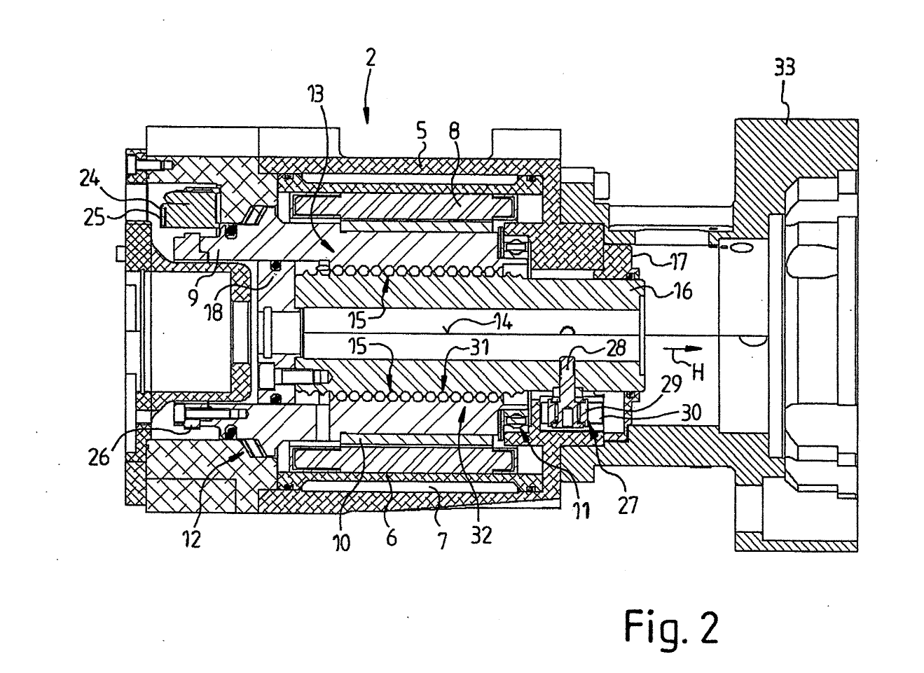

FIGS. 1 and 2 illustrate an electric release unit 1 which comprises an electric motor 2 with a stator 3 and a rotor 4. The stator 3 with electromagnetic coils 8 has at the peripheral side/outer side a stator housing 5 which forms with a stator ring 6 a hollow-cylindrical or annular cooling channel 7 for cooling water.

The rotor 4 comprises a rotor shaft 9 to which at the peripheral side permanent magnets 10 are fixed, in particular, adhesively bonded and bound. The rotor shaft 9 is supported with a ball bearing 11 and an angular roller bearing 12, wherein the latter can not only absorb radial forces, but also particularly axial forces.

The absorption of axial forces is quite particularly significant since a linear drive 13 or a conversion unit 13 is arranged “inside” the hollow-cylindrical rotor shaft 9. The rotation of the rotor 4 or the rotor shaft 9 is thereby advantageously converted into a linear adjustment or translation in an axial direction or in the direction of the (concentric) rotation axis 14 of the electric motor 2.

The linear drive 13 is constructed as a ball screw drive 13 so that it comprises numerous balls 15 as roller members 15. They are arranged, on the one hand, between the rotor shaft 9 which at the same time forms the spindle nut 9 of the linear drive 13 and a spindle element 16 and, on the other hand, between two plain bearings 17, 18 for supporting the spindle element 16 which in addition to the balls 15 can form a radial support/guide of the spindle element 16. An advantageous ball return unit to axially return the balls during operation is not illustrated in greater detail and is arranged/constructed inside the rotor shaft 9 as a channel.

With a rotating/running electric motor 2 or rotating rotor shaft 9, the spindle element 19 is adjusted along the rotation axis in the direction of a travel H. For example, a thread pitch of approximately 5 mm is provided and a travel H is approximately from 8 to 20 mm long and presses with approximately 45 kN so that the electric release unit 1 can replace a previously conventional hydraulic release unit, wherein a connection flange 33 has corresponding fixing possibilities or screw holes in order to be able to be screwed/fixed to the rear end of a motor spindle which is not illustrated in greater detail or a tool clamp.

In order to release such a tool clamp, there is provided a stop 19 which activates or releases a tension rod. In FIGS. 1 and 2, the spindle element 16 is illustrated in the non-activating position or idle position, that is to say, the spindle element 16 is “retracted”. In this retracted idle position, a sensor 20 or end switch 20 may advantageously detect or establish the rest position. In the illustrated variant, there is introduced in the hollow-cylindrical spindle element 16 a separate element 22, for example, magnet for a Hall sensor or the like, which the sensor 20 can advantageously detect. The sensor 20 may also be constructed as a proximity sensor 20 so that a groove 21 or recess together with the spindle element 16 advantageously makes the idle position detectable for the sensor 20. In FIG. 1, a second, separate element 23 is further schematically illustrated, whereby the stop position or deployed end position of the spindle element can be detected. For the deployed end position, the plain bearing element 18 advantageously has a stop for stopping on the rotor shaft 9.

Furthermore, there is provided a (relative) rotary encoder 24 which can detect the angular position of the rotor shaft 9. In this instance, a so-called encoder 25 and a tooth ring 26 are provided, whereby the angular position can be detected.

Furthermore, for the linear drive 13 preferably two linear guides 27 or torque supports 27 are provided. This supports the spindle element 16 in a peripheral direction on the stator 3, wherein a rotation of the spindle element 16 is effectively prevented. There is thereby produced with the rotating electric motor 2 or rotating rotor shaft 9 a relative movement between the rotor shaft 9 or spindle nut 9 and the spindle element 16 so that the spindle element 16 is advantageously adjusted in the direction H and, when the rotation direction of the electric motor 2 or the rotor shaft 9 is reversed, is returned again (counter to the direction H). Consequently, a release force in the direction H and where required a counter-force or clamping force counter to the direction H may be produced. The drive forces are advantageously transmitted via the balls 15 and corresponding thread turns 31, 32 of the rotor shaft 9 and the spindle element 16.

The axial forces are advantageously directed via the stop 19 or the spindle element 16 and via the balls 15, in particular, to the angular roller bearing 12.

For advantageous bearing or guiding, the linear guides 27 each have a fixing screw 28 on which a roller bearing 29 is supported with the outer ring and rollers as a roller member. The friction during linear guiding of the spindle element 16 on a planar guiding face 30 of the stator 3 is thereby reduced or minimized.

The spindle element 16 is constructed in a hollow-cylindrical manner in order centrally at the inner side to transport or direct a medium, in particular, a cooling lubricant or the like.

### LIST OF REFERENCE NUMERALS

1 Release unit
2 Electric motor
3 Stator
4 Rotor
5 Housing
6 Ring
7 Cooling channel
8 Coil
9 Rotor shaft
10 Permanent magnet
11 Bearing
12 Bearing
13 Linear drive
14 Rotation axis
15 Balls
16 Spindle element
17 Plain bearing
18 Plain bearing
19 Stop
20 Sensor
21 Groove
22 Element
23 Element
24 Rotary encoder
25 Encoder
26 Tooth ring
27 Linear guide
28 Screw
29 Roller bearing
30 Level
31 Thread turn
32 Thread turn
33 Connection flange

1. A release unit for a machine tool spindle for releasing a tool clamp, wherein the release unit comprises at least one adjustment element which can be linearly adjusted along an adjustment path for actuating the tool clamp, wherein the release unit is constructed as an electric motor which comprises an electromagnetic drive system having a hollow-cylindrical rotor shaft which rotates about a rotation axis, wherein the linearly adjustable adjustment element is constructed as a spindle element of a conversion unit for converting the rotation of the electric motor into a linear adjustment and wherein the rotor shaft is constructed as a spindle nut of the conversion unit which rotates about the rotation axis.

2. The release unit as claimed in claim 1, wherein the rotor shaft of the electric motor is constructed as a magnet carrier element which comprises at least one permanent magnet of the drive system.

3. The release unit as claimed in claim 1, wherein the rotor shaft of the electric motor comprises at least one thread turn of the conversion unit.

4. The release unit as claimed in claim 1, further comprising roller members arranged between the spindle nut and the spindle element.

5. The release unit as claimed in claim 1, wherein in order to support the rotor shaft, the electromagnetic drive system of the electric motor is substantially arranged between a first bearing and at least a second bearing.

6. The release unit as claimed in claim 5, wherein at least one of the bearings is constructed as an angular roller bearing.

7. The release unit as claimed in claim 4, wherein in order to support the spindle element, the roller members are arranged between a first plain bearing and at least a second plain bearing.

8. The release unit as claimed in claim 7, wherein the rotor shaft comprises at least a first sliding face of the first plain bearing and/or a stator of the electric motor comprises at least a second sliding face of the second plain bearing.

9. The release unit as claimed in claim 5, wherein the first and/or second bearing of the rotor shaft is constructed at least as an axial bearing of the spindle element for receiving forces which are orientated in the direction of the rotation axis.

10. The release unit as claimed in claim 1, wherein a stator of the electric motor comprises at least one linear guiding device for guiding the spindle element along the adjustment path.

11. A machine tool spindle having a release unit for releasing a tool from a retention device for retaining the tool in a processing phase, wherein the release unit is constructed as claimed in claim 1.

12. The release unit of claim 1, wherein the machine tool spindle is a motor spindle.
